(19) United States
(12) Patent Application Publication
(10) Pub. No.: US 2020/0310457 A1
(43) Pub. Date: Oct. 1, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Yuki Hara, Wako-shi (JP); Yasushi Shoda, Wako-shi (JP); Junpei Noguchi, Wako-shi (JP); Katsuyasu Yamane, Wako-shi (JP); Yoshitaka Mimura, Wako-shi (JP); Hiroshi Yamanaka, Wako-shi (JP); Ryoma Taguchi, Tokyo (JP); Yuta Takada, Tokyo (JP); Chie Sugihara, Tokyo (JP); Yuki Motegi, Tokyo (JP); Tsubasa Shibauchi, Tokyo (JP)

(21) Appl. No.: 16/819,213

(22) Filed: Mar. 16, 2020

(30) Foreign Application Priority Data
Mar. 26, 2019 (JP) 2019-058434

(51) Int. Cl. G05D 1/02; G01C 21/34; G08G 1/123; G06K 9/00

(52) U.S. Cl. CPC G05D 1/0246; G05D 1/0223; G01C 21/343; G06K 9/00664; G06K 9/00791; G05D 2201/0212; G05D 2201/0213; G08G 1/123

(57) ABSTRACT

A vehicle control device includes a vicinity situation recognizer configured to recognize a vicinity situation of a vehicle, and a driving controller configured to control steering and acceleration or deceleration of the vehicle on the basis of a vicinity situation recognized by the vicinity situation recognizer, in which the driving controller changes a priority level of an operation when the vehicle stops near users scheduled to board the vehicle on the basis of a type of the users scheduled to board.

### CROSS-REFERENCE TO RELATED APPLICATION

Priority is claimed on Japanese Patent Application No. 2019-058434, filed Mar. 26, 2019, the content of which is incorporated herein by reference.

### BACKGROUND

### Field

The present invention relates to a vehicle control device, a vehicle control method, and a storage medium.

### Description of Related Art

In recent years, research on automatic control of vehicles has been conducted. An autonomous traveling vehicle is disclosed, which includes an autonomous traveling controller that travels a route to a destination set in advance, a photographer that photographs an occupant in a vehicle compartment after boarding, a counter that recognizes an image photographed by the photographer and counts the number of occupants, and a determiner that determines whether the number of occupants counted by the counter exceeds a riding capacity, in which the autonomous traveling controller does not perform traveling of a vehicle when the determiner determines that the number of occupants exceeds the riding capacity, and starts the traveling of a vehicle when the determiner determines that the number of occupants does not exceed the riding capacity (Japanese Unexamined Patent Application, First Publication No. 2015-200933).

However, the processing of the autonomous traveling vehicle described above is processing in which the riding capacity is considered when the user has boarded the vehicle, and a pick-up operation may not be considered in some cases.

### SUMMARY

The present invention has been made in view of such circumstances, and an object thereof is to provide a vehicle control device, a vehicle control method, and a storage medium which are capable of performing appropriate pick-up operations according to the type of respective users.

A vehicle control device, a vehicle control method, and a storage medium according to this invention have adopted the following configurations.

(1): A vehicle control device according to one aspect of the present invention is a vehicle control device which includes a vicinity situation recognizer configured to recognize a vicinity situation of a vehicle, and a driving controller configured to control steering and acceleration or deceleration of the vehicle on the basis of the vicinity situation recognized by the vicinity situation recognizer, in which the driving controller changes a priority level of an operation when the vehicle stops near users scheduled to board the vehicle on the basis of a type of the users scheduled to board.

(2): In the aspect of (1) described above, in automated exit processing of causing the vehicle to exit from a parking lot and causing a user of the vehicle to board in a boarding area in which the user is allowed to board, the driving controller changes the priority level of an operation when the vehicle stops near the users scheduled to board on the basis of the type of the users scheduled to board.

(3): In the aspect of (1) or (2) described above, the type of the users includes at least three types such as an adult, a child, and an elderly person.

(4): In the aspect of any one of (1) to (3) described above, the type of the users includes a child, and the driving controller, when the users scheduled to board include one or more children, causes the vehicle to stop such that a door of the vehicle approaches near a position at which a child of interest among the one or more children waits to enable the one or more children to preferentially board the vehicle.

(5): In the aspect of (4) described above, the driving controller excludes a child who does not hold hands with one or more adults scheduled to board among the one or more children included in the users scheduled to board from the child of interest.

(6): In the aspect of (4) or (5) described above, the driving controller causes the vehicle to stop such that a door near a seat equipped with a child seat in a vehicle compartment of the vehicle approaches near the position at which the child of interest waits.

(7): In the aspect of (6) described above, the type of the users further includes an elderly person, and the driving controller, when an elderly person is included in the users scheduled to board in addition to the one or more children, causes the vehicle to move such that the door of the vehicle approaches near a position at which the elderly person waits to enable the elderly person to preferentially board the vehicle after all or some of the one or more children have boarded the vehicle.

(8): In the aspect of any one of (1) to (7) described above, the driving controller causes the vehicle to stop by controlling, with respect to a width direction of the vehicle, a distance between the vehicle and a user of interest among the users scheduled to board in the width direction according to the number of the users scheduled to board.

(9): In the aspect of any one of (1) to (8) described above, the vehicle is provided with a side step, and the driving controller causes the vehicle to stop at a position at which the side step can be used.

(10): In the aspect of any one of (1) to (9) described above, the vehicle is provided with a lift-up seat, and the driving controller takes the lift-up seat out of the vehicle after stopping when a user estimated to use the lift-up seat is included in the users scheduled to board.

(11): In the aspect of any one of (1) to (10) described above, the vehicle is provided with a slide door and a hinge door, and the driving controller determines a door of the vehicle which is closest to the user of interest among the users on the basis of one or both of clothes of the users scheduled to board and the type of the users scheduled to board, and causes the vehicle to stop such that the determined door is positioned near a position at which the user is present.

(12): A vehicle control method according to another aspect of the present invention is a vehicle control method which includes, by a vehicle control device, recognizing a vicinity situation of a vehicle, controlling steering and acceleration or deceleration of the vehicle on the basis of the recognized vicinity situation, and changing a priority level of an operation when the vehicle stops near users scheduled to board the vehicle on the basis of a type of the users scheduled to board.

(13): A storage medium according to still another aspect of the present invention is non-transitory computer-readable storage medium storing a computer program to be executed by a computer to perform at least: recognize a vicinity situation of a vehicle; control steering and acceleration or deceleration of the vehicle on the basis of the recognized vicinity situation; and change a priority level of an operation when the vehicle stops near users scheduled to board the vehicle on the basis of a type of the users scheduled to board.

According to (1) to (3), (7), (12), and (13), an appropriate pick-up operation according to the type of the users is performed.

According to (4) to (6), furthermore, an appropriate pick-up operation is performed for a child and a guardian of the child.

According to (8), furthermore, the user can board the vehicle smoothly.

According to (9) and (10), an appropriate pick-up operation is performed for the user of the vehicle and an assistant of the user.

According to (11), it is possible to provide a pick-up service in consideration of clothing of the user of the vehicle.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram which schematically shows a scene in which an autonomous parking event is executed.

FIG. 4 is a diagram which shows an example of a configuration of a parking lot management device.

FIG. 5 is a diagram which shows an example of an image in which a user waiting in a getting-on/off area is captured by a camera.

FIG. 6 is a diagram which shows an example of a position at which a host vehicle stops when a child is present.

FIG. 7 is a diagram for describing an example of a method of determining a position at which the host vehicle stops when a child is present.

FIG. 8 is a diagram which shows an example of a scene in which two children are present in users scheduled to board.

FIG. 9 is a diagram for describing an example of processing performed when a child and a specific user are present.

FIG. 10 is a flowchart which shows an example of a flow of processing executed by an automated driving control device.

FIG. 11 is a diagram for describing an example of control when the number of the users scheduled to board is one.

FIG. 12 is a diagram for describing an example of control when the number of the users scheduled to board is two or more.

FIG. 13 is a diagram which shows an example of a position at which a host vehicle provided with a side step allows a user to board.

FIG. 14 is a diagram which shows an example of a position at which a host vehicle provided with a lift-up seat allows a user to board.

FIG. 15 is a diagram which shows an example of a position at which a host vehicle provided with a slope allows a user to board.

FIG. 16 is a diagram which shows an example of a functional configuration of an automated driving control device according to a second embodiment.

FIG. 17 is a flowchart which shows an example of a flow of processing executed by the automated driving control device according to the second embodiment.

FIG. 18 is a diagram which schematically shows content of processing of steps S200 to S204.

FIG. 19 is a diagram which shows an example of a host vehicle M stopped such that a door provided with a slide door approaches a user wearing kimono.

FIG. 20 is a diagram which shows an example of a hardware configuration of the automated driving control device according to the embodiment.

### DETAILED DESCRIPTION

Hereinafter, embodiments of a vehicle control device, a vehicle control method, and a storage medium of the present invention will be described with reference to the drawings.

### First Embodiment

### Overall Configuration

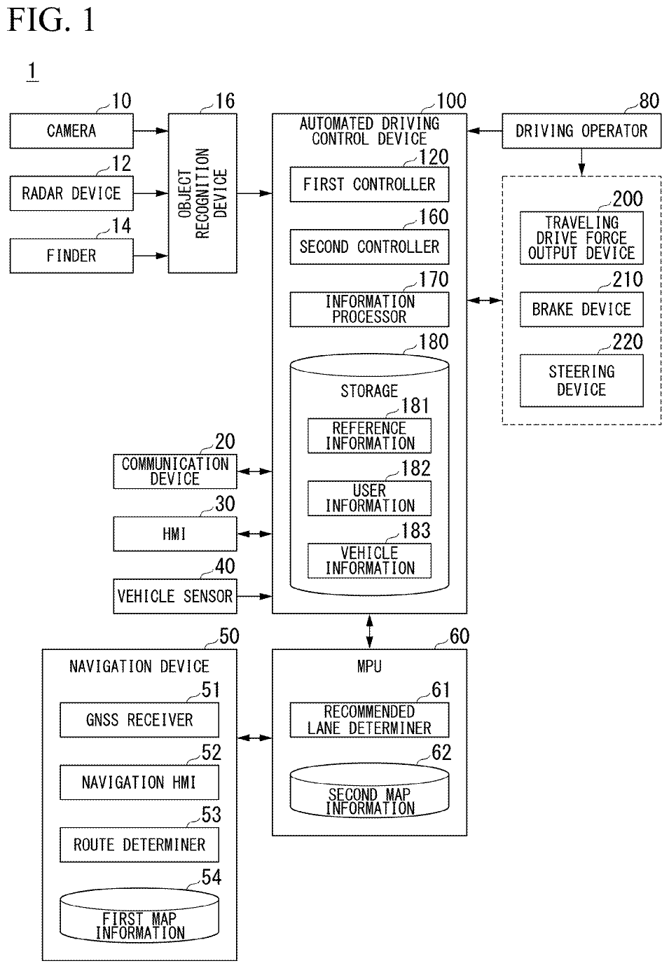

FIG. 1 is a configuration diagram of a vehicle system 1 using a vehicle control device according to an embodiment. A vehicle on which the vehicle system 1 is mounted is, for example, two-wheel, three-wheel, or four-wheel vehicle, and a driving source thereof is an internal combustion engine such as a diesel engine or a gasoline engine, an electric motor, or a combination thereof. The electric motor operates using electric power generated by a generator connected to the internal combustion engine, or electric power discharged from a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices or apparatuses are connected to each other via a multiplex communication line such as a controller area network (CAN) communicator line, a serial communication line, a wireless communication network, or the like. The configuration illustrated I FIG. 1 is merely an example, and part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to an arbitrary position of a vehicle (hereinafter, a host vehicle M) on which the vehicle system 1 is mounted. When the front is imaged, the camera 10 is attached to an upper part of the front windshield, a rear surface of the rearview mirror, or the like. The camera 10 periodically and repeatedly captures images of a vicinity of the host vehicle M. The camera 10 may also be a stereo camera.

The radar device 12 radiates radio waves such as millimeter waves to the vicinity of the host vehicle M and detects at least a position (a distance and an orientation) of an object by detecting radio waves (reflected waves) reflected by the object. The radar device 12 is attached to an arbitrary position of the host vehicle M. The radar device 12 may detect the position and a speed of the object using a frequency modulated continuous wave (FM-CW) method.

The finder 14 is a light detection and range (LIDAR). The finder 14 radiates light to the vicinity of the host vehicle M and measures scattered light. The finder 14 detects a distance to the object on the basis of time from light emission and light reception. The radiated light is, for example, pulsed laser light. The finder 14 is attached to an arbitrary position of the host vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection by the camera 10, the radar device 12, and the finder 14 to the automated driving control device 100 as they are. The object recognition device 16 may be omitted from the vehicle system 1.

The communication device 20 uses, for example, a cellular network, a Wi-Fi network, a Bluetooth (a registered trademark), a dedicated short range communication (DSRC), or the like, and communicates with another vehicle or a parking lot management device (to be described below) present in the vicinity of the host vehicle M or various types of server devices.

The HMI 30 presents various types of information to a user of the host vehicle M and receives an input operation from the user. The HMI 30 includes various display devices, speakers, buzzers, touch panels, switches, keys, and the like.

The vehicle sensor 40 includes a vehicle speed sensor for detecting a speed of the host vehicle M, an acceleration sensor for detecting acceleration, a yaw rate sensor for detecting an angular speed around a vertical axis, an orientation sensor for detecting a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position (or an arbitrary input position) of the host vehicle M identified by the GNSS receiver 51 to a destination input from the user using the navigation HMI 52 with reference to the first map information 54. The first map information 54 is, for example, information in which a road shape is expressed by a link indicating a road and a node connected by the link. The first map information 54 may include curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smart phone or a tablet terminal owned by the user. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle traveling direction) and determines a recommended lane for each block with reference to the second map information 62. The recommended lane determiner 61 determines which numbered lane to travel from the left. When there is a branch point in the route on a map, the recommended lane determiner 61 determines a recommended lane such that the host vehicle M travels in a reasonable route for traveling to a branch destination.

The second map information 62 is map information with higher accuracy than the first map information 54. The second map information 62 includes, for example, information on a center of a lane or information on a boundary of the lane. The second map information 62 may include road information, traffic regulation information, address information (addresses/postal codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steer, a joystick, and other operators. A sensor that detects an operation amount or a presence or absence of an operation is attached to the driving operator 80, and this detection result is output to the automated driving control device 100 or some or all of the traveling drive force output device 200, the brake device 210, and the steering device 220.

The automated driving control device 100 includes, for example, a first controller 120, a second controller 160, an information processor 170, and a storage 180. The first controller 120 and the second controller 160 are realized, for example, by a hardware processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), and a graphics processing unit (GPU), and may also be realized by a cooperation of software and hardware. The program may be stored in advance in a storage device (a storage device including a non-transitory storage medium) such as an HDD or a flash memory of the automated driving control device 100, or may be stored in a detachable storage medium such as a DVD or a CD-ROM and installed in the HDD or the flash memory of the automated driving control device 100 by the storage medium (the non-transitory storage medium) being mounted on a drive device.

The storage 180 is realized by an HDD, a flash memory, an electrically erasable programmable read only memory (EEPROM), a read only memory (ROM), a random access memory (RAM), or the like. The storage 180 stores, for example, reference information 181, user information 182, vehicle information 183, and the like (details will be described below).

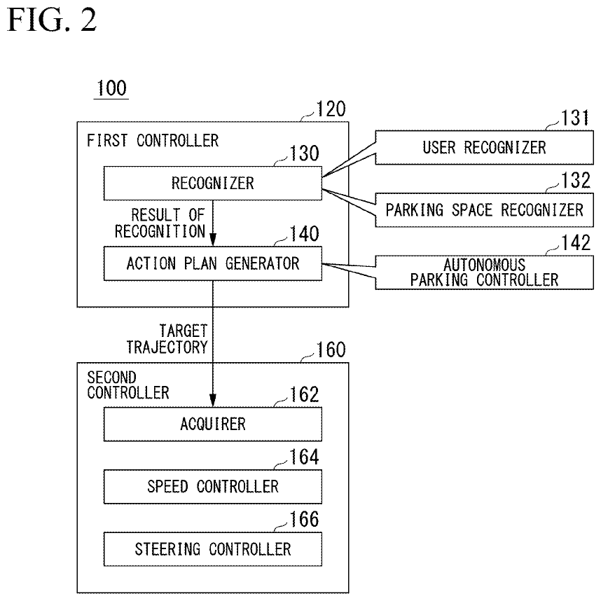

FIG. 2 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a model given in advance in parallel. For example, a function of “recognizing an intersection” may be realized by executing a recognition of an intersection by deep learning or the like and a recognition based on conditions (including pattern matching signals, road markings, and the like) given in advance in parallel and comprehensively evaluating the both by scoring them. As a result, a reliability of automated driving is guaranteed.

The recognizer 130 recognizes states such as the position, speed and acceleration of the object in the vicinity of the host vehicle M on the basis of information input from the camera 10, the radar device 12, and the finder 14 via the object recognition device 16. The position of the object is, for example, recognized as a position on absolute coordinates having the origin at a representative point (a center of gravity, a center of a drive axis, or the like) of the host vehicle M, and is used for control. The position of the object may be represented by a representative point such as a center of gravity or a corner of the object, or may be represented by an expressed area. A “state” of the object may include the acceleration or jerk of the object, or an “action state” (for example, whether a lane is changed or is intended to be changed).

The recognizer 130 recognizes, for example, a lane (traveling lane) in which the host vehicle M is traveling. For example, the recognizer 130 recognizes a traveling lane by comparing a pattern (for example, an array of solid lines and dashed lines) of a road section line obtained from the second map information 62 with a pattern of a road section line in the vicinity of the host vehicle M recognized from an image captured by the camera 10. The recognizer 130 may recognizes a traveling lane by recognizing not only a road section line but also a traveling road boundary (road boundary) including road section lines, road shoulders, curbs, median strips, guardrails, and the like. In this recognition, the position of the host vehicle M acquired from the navigation device 50 and a result of processing performed by the INS may be added. The recognizer 130 recognizes temporary stop lines, obstacles, red light, tollgates, or other road events.

When a traveling lane is recognized, the recognizer 130 recognizes the position and posture of the host vehicle M with respect to the traveling lane. The recognizer 130 may recognize, for example, a deviation of a reference point of the host vehicle M from a lane center and an angle formed with respect to a line connecting the lane centers in a traveling direction of the host vehicle M as the relative position and posture of the host vehicle M with respect to the traveling lane. Instead, the recognizer 130 may recognize a position and the like of the reference point of the host vehicle M with respect to either side end (a road section line or a road boundary) of the traveling lane as the relative position of the host vehicle M with respect to the traveling lane.

The recognizer 130 includes a user recognizer 131 and a parking space recognizer 132 which is started in an autonomous parking event. Details of functions of the user recognizer 131 and the parking space recognizer 132 will be described below.

In principle, the action plan generator 140 travels on a recommended lane determined by the recommended lane determiner 61, and furthermore, generates a target trajectory in which the host vehicle M will automatically (without depending on an operation of the driver) travel to be able to cope with the vicinity situation of the host vehicle M. The target trajectory includes, for example, a speed element. For example, the target trajectory is expressed as a sequence of points (orbit points) to be reached by the host vehicle M. The orbit points are points to be reached by the host vehicle M for each predetermined traveling distance (for example, about several [m]) in a road distance, and separately from this, a target speed and a target acceleration for each predetermined sampling time (for example, about 0 commas [sec]) are generated as part of the target trajectory. The orbit points may be positions to be reached by the host vehicle M at a corresponding sampling time for each predetermined sampling time. In this case, the information on the target speed and the target acceleration is expressed by an interval between the orbit points.

The action plan generator 140 may set an automated driving event in generation of a target trajectory. Examples of the automated driving event include a constant-speed traveling event, a low-speed following traveling event, a lane change event, a branching event, a merging event, a takeover event, an autonomous parking event in which unmanned traveling (or automated traveling) is performed to park in valet parking and the like, and the like. The action plan generator 140 generates a target trajectory in accordance with a started event. The action plan generator 140 includes an autonomous parking controller 142 which is started when an autonomous parking event is executed. Details of functions of the autonomous parking controller 142 will be described below.

The second controller 160 controls the traveling drive force output device 200, the brake device 210, and the steering device 220 such that the host vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information on the target trajectory (orbit points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 in accordance with a bending condition of the target trajectory stored in the memory. Processing of the speed controller 164 and the steering controller 166 is realized by, for example, a combination of feed forward control and feedback control. As an example, the steering controller 166 executes a combination of the feed forward control in accordance with curvature of a road in front of the host vehicle M and the feedback control based on a deviation from the target trajectory.

The information processor 170 manages information acquired by the automated driving control device 100 or executes various types of processing for the acquired information. Details of the processing of the information processor 170 will be described below.

The traveling drive force output device 200 outputs a traveling drive force (torque) for a traveling of a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor according to the information input from the second controller 160 or the information input from the driving operator 80 such that a brake torque corresponding to a braking operation is output to each wheel. The brake device 210 may include, as a backup, a mechanism that transmits the hydraulic pressure generated by an operation of the brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes a direction of the steering wheel by, for example, applying a force to a rack and pinion mechanism. The steering ECU drives the electric motor and changes the direction of the steering wheel according to the information input from the second controller 160 or the information input from the driving operator 80.

### Autonomous Parking Event-at the Time of Entrance

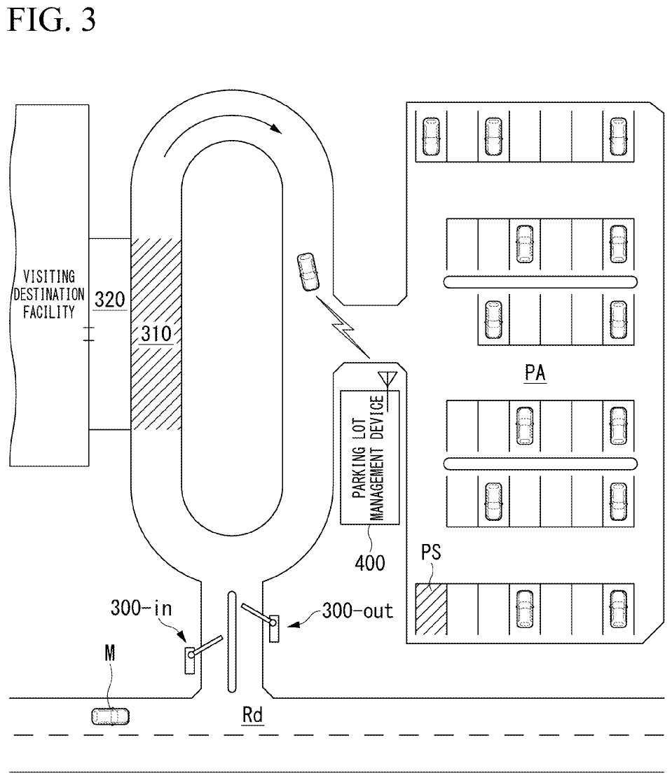

The autonomous parking controller 142 causes the host vehicle M to park in a parking space on the basis of, for example, information acquired from the parking lot management device 400 by the communication device 20. FIG. 3 is a diagram which schematically shows a scene in which an autonomous parking event is executed. In a route from a road Rd to a visiting destination facility, gates 300-in and 300-out are provided. The host vehicle M proceeds to a stop area 310 after passing through the gate 300-in by manual driving or automated driving. The stop area 310 faces a getting-on/off area 320 connected to the visiting destination facility. The getting-on/off area 320 is provided with an eave for avoiding rain and snow.

The host vehicle M starts an autonomous parking event in which unmanned (or manned) automated driving and moving to a parking space PS in a parking lot PA are performed after the user is dropped at the stop area 310. A start trigger of the autonomous parking event may be, for example, some operations performed by the user, or may be a reception of a predetermined signal wirelessly from the parking lot management device 400. The autonomous parking controller 142 controls the communication device 20 such that it transmits a parking request to the parking lot management device 400 when the autonomous parking event is started. Then, the host vehicle M moves from the stop area 310 to the parking lot PA according to a guidance of the parking lot management device 400 or while performing sensing by itself.

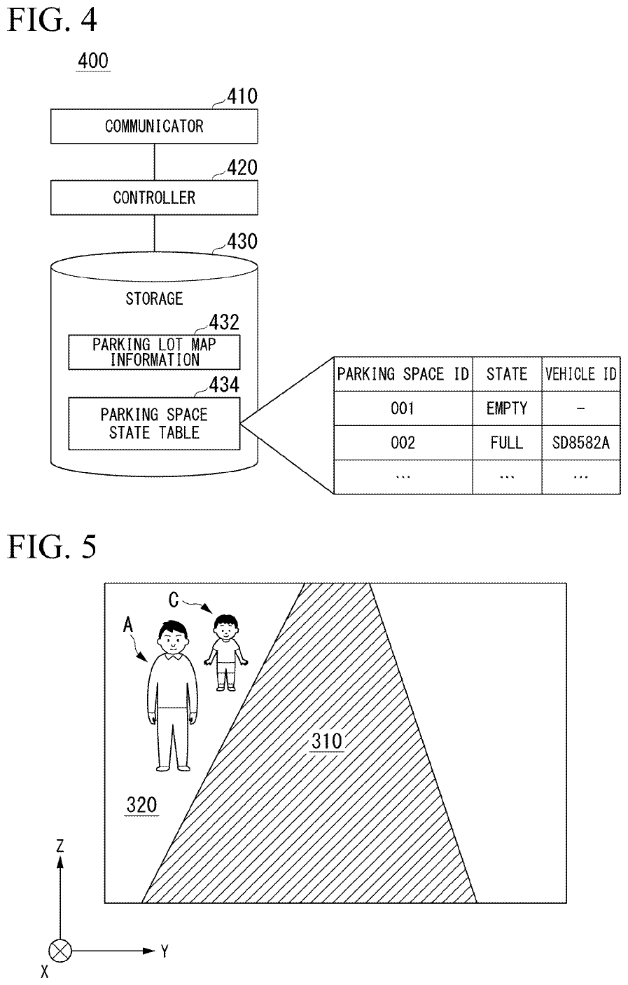

FIG. 4 is a diagram which shows an example of a configuration of the parking lot management device 400. The parking lot management device 400 includes, for example, a communicator 410, a controller 420, and a storage 430. The storage 430 stores information such as parking lot map information 432 and information on a parking space state table 434 and the like.

The communicator 410 wirelessly communicates with the host vehicle M and other vehicles. The controller 420 guides a vehicle to the parking space PS on the basis of information acquired by the communicator 410 and information stored in the storage 430. The parking lot map information 432 is information in which a structure of the parking lot PA is geometrically represented. The parking lot map information 432 includes coordinates for each parking space PS.

The parking space state table 434 is a table in which, for example, a state indicating whether the parking space PS is in an empty state or a full (parking) state and a vehicle ID that is identification information of a parking vehicle when in the full state are associated with a parking space ID that is identification information of the parking space PS.

If the communicator 410 receives the parking request from a vehicle, the controller 420 extracts a parking space PS which is in the empty state with reference to the parking space state table 434, acquires a position of the extracted parking space PS from the parking lot map information 432, and transmits a preferred route to the position of the acquired parking space PS to the vehicle using the communicator 410. The controller 420 instructs a specific vehicle to stop or slow down when necessary on the basis of a positional relationship of a plurality of vehicles such that vehicles do not proceed to the same position at the same time.

In the vehicle that has received the route (hereinafter, referred to as the host vehicle M), the autonomous parking controller 142 generates a target trajectory based on the route. If a target parking space PS is approached, the parking space recognizer 132 recognizes a parking frame line or the like that partitions the parking space PS, and recognizes a detailed position of the parking space PS to provide it to the autonomous parking controller 142. The autonomous parking controller 142 corrects the target trajectory after receiving this and causes the host vehicle M to park in the parking space PS.

### Autonomous Parking Event-at the Time of Exit

The autonomous parking controller 142 and the communication device 20 maintain an operating state even while the host vehicle M parks. The autonomous parking controller 142 causes a system of the host vehicle M to start and causes the host vehicle M to move to the stop area 310, for example, when the communication device 20 receives a pick-up request from a terminal device of the user (in the following description, this processing may be referred to as “automated exit processing.”). At this time, the autonomous parking controller 142 controls the communication device 20 and transmits a take-off request to the parking lot management device 400. The controller 420 of the parking lot management device 400 instructs a specific vehicle to stop or slow down when necessary on the basis of the positional relationship of a plurality of vehicles such that the vehicles do not proceed to the same position at the same time. If the host vehicle M is moved to the stop area 310 to allow the user to board, the autonomous parking controller 142 stops operating, and thereafter, manual driving or automated driving performed by another functional part is started.

The autonomous parking controller 142 is not limited to the description above, and may find a parking space in the empty state by itself on the basis of a result of detection performed by the camera 10, the radar device 12, the finder 14, or the object recognition device 16 independently of communication, and cause the host vehicle M to park in the found parking space.

In the following description, a positional relationship and the like will be described using an XYZ coordinate system as appropriate. An X direction is a center axis direction (forward direction) of a vehicle body and a Y direction is a direction orthogonal to the X direction in a width direction of the vehicle, that is, in a horizontal plane. A Z direction is a direction orthogonal to the X direction and the Y direction.

### Outline of Processing (Specific Processing) Based on Type of User

The automated driving control device 100 changes a priority level of an operation when the vehicle stops near users scheduled to board the host vehicle M on the basis of a type of the user scheduled to board (hereinafter, this processing may be referred to as “specific processing.”). The type of the users includes, for example, at least three types such as an adult, a child, and an elderly person. In the following description, it is described that the automated driving control device 100 performs the specific processing in automated exit processing of causing the host vehicle M to exit from the parking lot PA and allowing a user of the host vehicle M to board in the getting-on/off area 320 in which the user is allowed to board, but the specific processing may also be performed even when the automated exit processing is not performed.

“Type” includes, for example, an adult, a child, height, appearance, a classification result based on a predetermined reference, and the like. The “change of a priority level of an operation when the vehicle stops” includes, for example, a change in stop position of the host vehicle M with priority, a change in state of on-vehicle equipment provided in the host vehicle M with priority when the vehicle has stopped, and the like.

FIG. 5 is a diagram which shows an example of an image in which a user waiting in a getting-on/off area 320 is captured by the camera 10. For example, the automated driving control device 100 identifies the “users scheduled to board” for the host vehicle M on the basis of a rule predetermined in the automated exit processing or position information transmitted by the parking lot management device 400, a portable terminal device held by the users, or the like. The rule described above is, for example, a definition of a waiting position in the getting-on/off area 320. The automated driving control device 100 may group the user scheduled to board and persons in the vicinity of the users, and identify all the grouped persons as the “users scheduled to board.”

The user recognizer 131 recognizes a type of the users scheduled to board the host vehicle M. For example, the user recognizer 131 refers to the reference information 181 stored in the storage 180, and identifies the type of the users on the basis of an image captured by the camera 10. There are two users (C and A in FIG. 5) waiting in the getting-on/off area 320 as shown in FIG. 5 in the image captured by the camera 10. The reference information is, for example, information in which the type of users and a distribution of feature amounts of the image are associated with each other. The feature amount is, for example, an index based on a luminance value, a luminance gradient, or the like.

The user recognizer 131 may refer to the user information 182 and identify the type of the users on the basis of the image captured by the camera 10. The user information 182 includes a distribution of feature amounts of the users registered in advance and various types of information. The various types of information include, for example, information indicating an adult, a child, age, gender, and the like. The various types of information include, for example, a distribution of feature amounts derived on the basis of an image in which the user who has boarded the host vehicle M within a predetermined period or most recently is captured by a camera in the vehicle compartment, a distribution of feature amounts derived on the basis of an image registered by a predetermined operation of the user, and the like. The various types of information may be information based on an operation of the user, or may be information derived by the user recognizer 131 on the basis of the image in which the user is captured and a predetermined algorithm or a predetermined model.

For example, the automated driving control device 100 determines a user of interest among the users scheduled to board, and controls the host vehicle M such that a predetermined door of the host vehicle M approaches a position at which the determined user waits. Then, the automated driving control device 100 causes the host vehicle M to stop such that the predetermined door of the host vehicle M is positioned near the position at which the user waits.

The user of interest is a user who is allowed to preferentially board the host vehicle M by the automated driving control device 100. The user of interest is, for example, any one of the following items (1) to (3) when, for example, a child or a specific user (to be described below) is not included in the users scheduled to board.

(1) A user scheduled to board and present at a position closest to a current position of the host vehicle M.

(2) A user to be allowed to board first among users in an assumed situation. The assumed situation is one in which the information processor 170, when users board the host vehicle M, has assumed an order of the users' boarding such that a total movement amount of the users scheduled to board is minimized

(3) A user to be allowed to board first when it is assumed to allow the users scheduled to board to efficiently board the host vehicle M. The predetermined door is, for example, an arbitrary door, a door set in advance, or a door determined on the basis of the type of a user among doors provided in the host vehicle M.

### Processing Performed when Child is Present (Part 1)

When one or more children are included in the users scheduled to board, the first controller 120 of the automated driving control device 100 causes the host vehicle M to stop such that a door of the host vehicle M approaches near a position at which a child of interest among one or more children waits to enable the one or more children to preferentially board the host vehicle M.

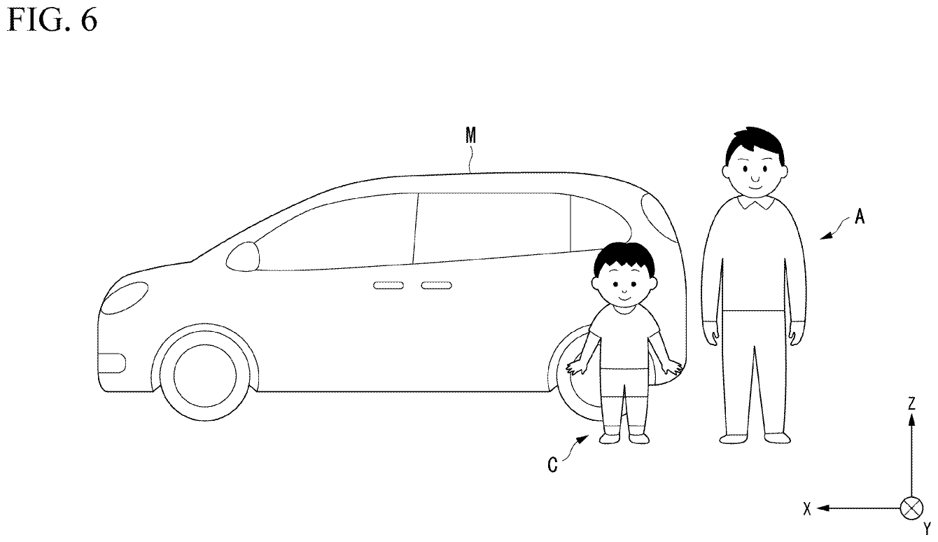

FIG. 6 is a diagram which shows an example of a position at which the host vehicle M stops when a child is present. For example, when a child is present, the automated driving control device 100 causes the host vehicle M to stop at a position at which the child can easily board the host vehicle M.

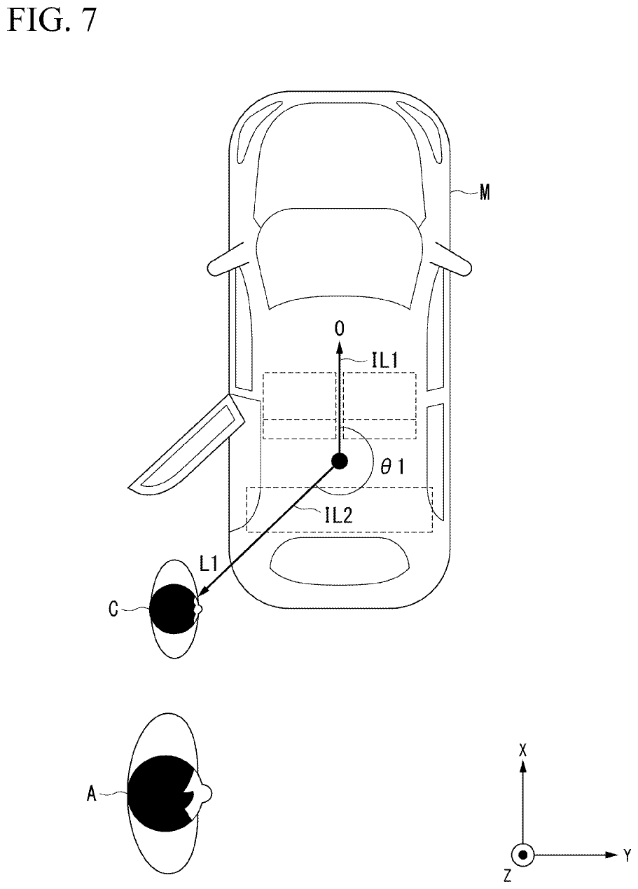

FIG. 7 is a diagram for describing an example of a method of determining a position at which the host vehicle M stops when a child is present. The information processor 170 sets a first virtual line IL1 extending in the X direction of the host vehicle M from a reference position of the host vehicle M, and sets a second virtual line IL2 obtained by rotating the first virtual line IL1 by an angle 01 based on the first virtual line IL1. In the example of FIG. 7, it is assumed that a child sits on a backseat, and the predetermined door is set as a backseat on the minus Y side. In this case, the angle 01 may be, for example, between 180 degrees and 270 degrees. Furthermore, the information processor 170 causes the second virtual line IL2 to extend by a predetermined distance L1, and sets a tip of the extended second virtual line IL2 as a reference position.

Then, the automated driving control device 100 causes the host vehicle M to stop such that the user matches the reference position set by the information processor 170 with respect to the position of the host vehicle M. The reference position is a position that does not overlap with a trajectory of the door when the door of the host vehicle M is opened.

As a result, since the host vehicle M stops at a position at which the child easily boards, the child can preferentially board the host vehicle M. In this manner, the automated driving control device 100 can perform an appropriate pick-up operation for the users scheduled to board the host vehicle M.

### Processing Performed When a Child is Present (Part 2)

The automated driving control device 100 excludes a child who is not holding hands with one or more adults scheduled to board among one or more children from the child of interest. To “exclude” means to treat the child as an adult instead of a child or to assign a lower priority level than the child of interest.

For example, when there is a child included in the users scheduled to board and the child is holding hands with one or more adults scheduled to board, the automated driving control device 100 causes the host vehicle M to stop on the basis of the reference position such that the child holding hands with the adult(s) can preferentially board the host vehicle M. When there is a child included in the users scheduled to board and the child is not holding hands with one or more adults scheduled to board, the automated driving control device 100 may determine a stop position to allow the child to preferentially board the host vehicle M or determine the stop position of the host vehicle M on the basis of other factors. Other factors include, for example, a position of the user scheduled to board which is present at the closest position to a current position of the host vehicle M, a position at which a total amount of movements of the users scheduled to board when boarding the host vehicle M is the smallest, or a position at which the users scheduled to board can board the host vehicle M efficiently. For example, in the processing described above, the priority level in boarding the host vehicle M is higher in order of a child holding hands and a child of younger age among a plurality of children. For example, the user recognizer 131 performs image processing to identify that a child holds hands with an adult, an age of the child, and the like.

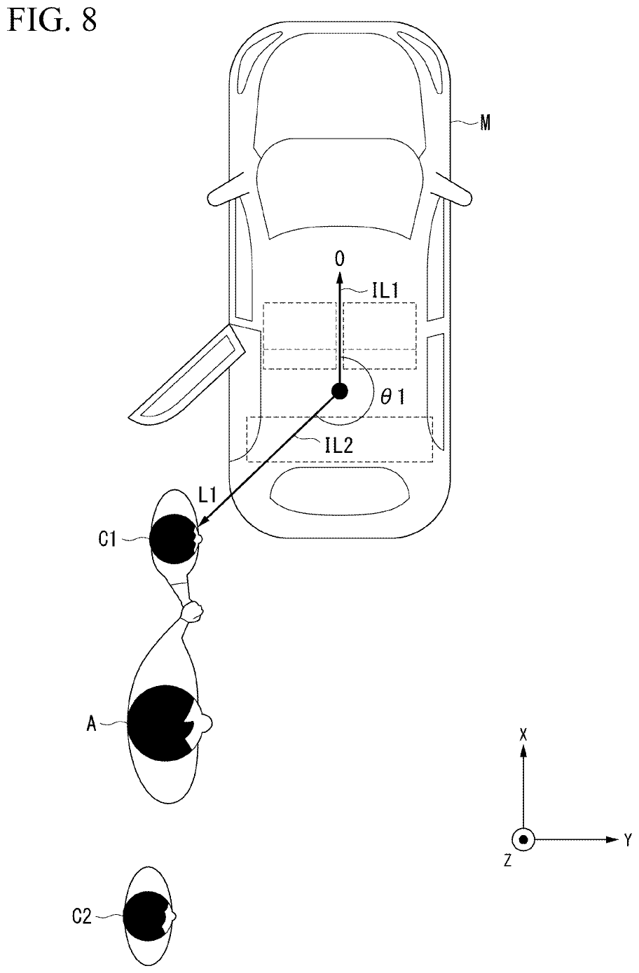

FIG. 8 is a diagram which shows an example of a scene in which two children are present in the users scheduled to board. The user recognizer 131 performs image processing to recognize that a child C1 among the child C1 and a child C2 and an adult A are holding hands, and the child C2 and the adult A are not holding hands. In this case, the automated driving control device 100 causes the host vehicle M to stop at a position at which the child C1 holding hands with the adult can easily board.

For example, it may be more difficult for a child holding hands with an adult to board the host vehicle M by himself than a child not holding hands with an adult. For this reason, the automated driving control device 100 causes the host vehicle M to stop at a position at which the child holding hands with an adult easily board, so that the automated driving control device 100 can perform an appropriate pick-up operation for the users scheduled to board the host vehicle M.

For example, when two or more children included in the users scheduled to board are present and one of the two or more children holds hands with one or more adults scheduled to board, the automated driving control device 100 causes the host vehicle M to stop on the basis of the reference position such that the child holding hands can preferentially board the host vehicle M. When two or more children included in the users scheduled to board are present and the two or more children hold hands with one or more adults scheduled to board, the automated driving control device 100 causes the host vehicle M to stop on the basis of the reference position such that a first child among these children can preferentially board the host vehicle M. In this case, the automated driving control device 100 causes the host vehicle M to stop such that a second child can preferentially board the host vehicle M after the first child has boarded. For example, the automated driving control device 100 may cause the host vehicle M to stop such that a younger child (a child estimated to be younger) among a plurality of children is allowed to preferentially board.

In the processing described above, the automated driving control device 100 may cause the host vehicle M to stop such that a door near a seat equipped with a child seat in the vehicle compartment of the host vehicle M approaches near a position at which the child of interest (the child holding hands) waits. For example, the vehicle information 183 stores information of the seat equipped with a child seat. The information is information registered for a user or information derived on the basis of an image captured by a camera in the vehicle compartment. As a result, a convenience of the adult helping the child holding hands to board the host vehicle M is further improved.

### Processing Performed when a Child and a Specific User are Present

When a specific user in addition to one or more children is included in the users scheduled to board, the automated driving control device 100 causes the host vehicle M to move such that the door of the host vehicle M approaches near a position at which the specific user waits to enable the specific user to preferentially board the host vehicle M after all or some of the one or more children have boarded the host vehicle M. The “specific user” is an elderly person whose age is equal to or more than a predetermined age, a user whose preferential boarding is registered in advance in the automated driving control device 100, or the like.

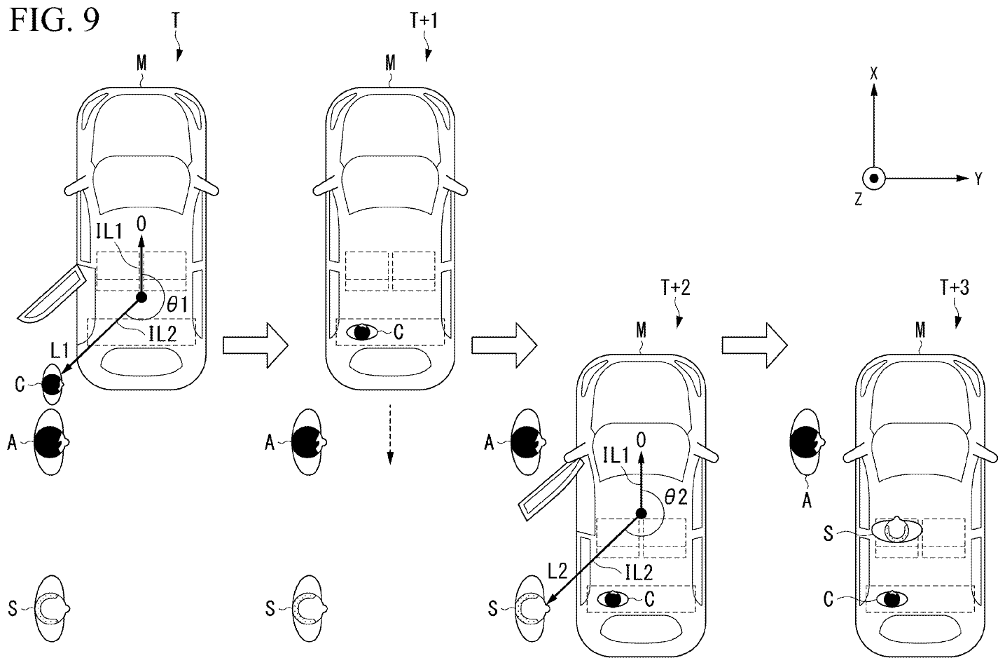

FIG. 9 is a diagram for describing an example of processing performed when a child and a specific user are present. In the example of FIG. 9, a child, an adult, and an elderly person are included in the users scheduled to board. At a time T, the automated driving control device 100 causes the host vehicle M to stop at a position at which a child C easily boards the host vehicle M. At a time T+1, the child C boards the host vehicle M. At a time T+2, after the child C has boarded the host vehicle M, the automated driving control device 100 causes the host vehicle M to move backward and stop at a position at which an elderly person S easily board the host vehicle M. At a time T+3, the elderly person S boards the host vehicle M.

In this manner, since the host vehicle M stops at a position at which a child easily boards and, after the child has boarded, stops at a position at which a specific user easily boards to cause the specific user to board, the users scheduled to board can smoothly board the host vehicle M, and since the convenience of the users scheduled to board is improved and more efficient boarding is performed, a parking lot can be operated more efficiently.

The automated driving control device 100, when two or more children are present, may allow a specific user to board after all of the children have boarded, or may allow the specific user to preferentially board over other children after allowing a predetermined child (for example, a child holding hands with an adult) to board. An order of boarding may be determined on the basis of a priority level set in advance. For example, the priority level may increase in order of a specific user and a child.

### Flowchart

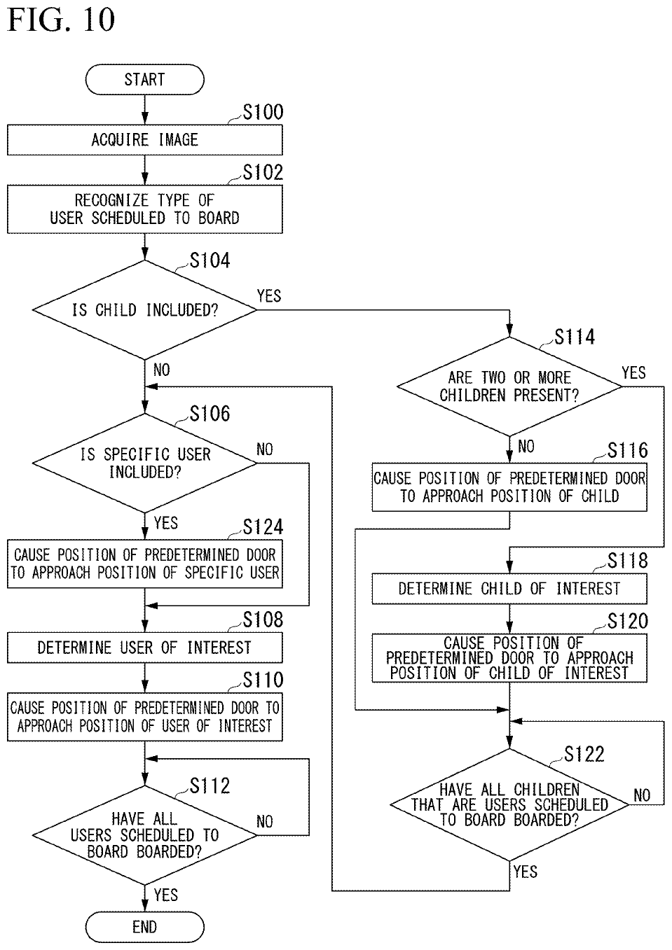

FIG. 10 is a flowchart which shows an example of a flow of processing executed by the automated driving control device 100. For example, the present processing is executed when the host vehicle M approaches a position at a predetermined distance from the getting-on/off area 320.

First, the user recognizer 131 acquires an image captured by the camera 10 (step S100), and recognizes a type of users scheduled to board on the basis of the acquired image (step S102). Next, the user recognizer 131 determines whether a child is included in the users scheduled to board on the basis of a result of the recognition in step S102 (step S104).

When it is determined that a child is not included in step S104, the user recognizer 131 determines whether a specific user is included in the users scheduled to board on the basis of a result of the recognition in step S102 (step S106). When it is determined that a specific user is not included in step S106, the information processor 170 determines a user of interest among the users scheduled to board (step S108).

The automated driving control device 100 causes the host vehicle M to stop at a position in which a position of the predetermined door approaches a position in which the user of interest is present (step S110). Next, the automated driving control device 100 determines whether all of the users scheduled to board have boarded (step S112). When all of the users scheduled to board have boarded, processing of one routine of this flowchart ends.

When it is determined that a child is not included in step S104, the user recognizer 131 determines whether a plurality of children are present on the basis of a result of the recognition in step S102 (step S114). When it is determined that the plurality of children are not present in step S114, the automated driving control device 100 causes the host vehicle M to stop such that the position of the predetermined door approaches the position in which the child recognized in step S102 is present (step S116).

When it is determined that the plurality of children are present in step S114, the information processor 170 determines a child of interest among the plurality of children (step S118) and causes the host vehicle M to stop such that the position of the predetermined door approaches the position in which the child is present (step S120). Here, when the plurality of children are present, after the processing of step S120, the automated driving control device 100 may determine a child of interest next to the child who has boarded after the vehicle stops in the processing of step S120, cause the host vehicle M to stop such that the predetermined door approaches a position close to a position in which the determined child of interest is present, and cause the child of interest to board the host vehicle M. After the processing of step S116 or step S120, the automated driving control device 100 determines whether all of children who are the users scheduled to board have boarded, and proceeds to the processing of step S106 when all of the children who are the users scheduled to board have boarded (step S122). For example, after the processing of step S116, when boarding of the child recognized in step S102 has completed, the procedure proceeds to step S106, and, when boarding of the plurality of children recognized in step S102 has completed after the processing of step S120, the procedure proceeds to step S106.

When it is determined that the specific user is included in step S106, the automated driving control device 100 causes the host vehicle M to stop such that the position of the predetermined door approaches a position in which the specific user recognized in step S102 is present (step S124). After the specific user has boarded, the procedure proceeds to the processing of step S108. When a plurality of specific users are present, the vehicle may also be moved such that the specific users easily board in order of higher priority level. As a result, processing of one routine of this flowchart ends.

According to the processing described above, the automated driving control device 100 can perform an appropriate pick-up operation for the users scheduled to board the vehicle.

### Control of Host Vehicle in Width Direction According to the Number of Persons Scheduled to Board

The automated driving control device 100 causes the host vehicle M to stop by controlling a distance between the host vehicle M and a person of interest among the users scheduled to board in a width direction of the host vehicle M according to the number of persons scheduled to board. For example, the automated driving control device 100 changes a position at which the host vehicle M stops for the users scheduled to board according to the number of persons scheduled to board. For example, the automated driving control device 100 causes the host vehicle M to stop at a position at which a distance between the user scheduled to board and the host vehicle M in a lateral direction is shorter when a plurality of users scheduled to board are present than when the number of the users scheduled to board is one.

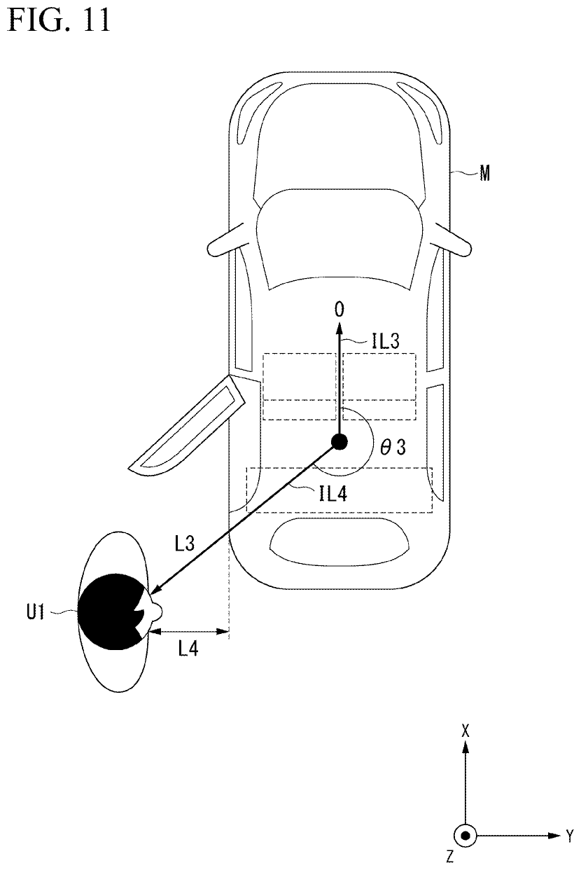

FIG. 11 is a diagram for describing an example of control when the number of the users scheduled to board is one. When the number of the users scheduled to board is one, the information processor 170 sets a third virtual line IL3 extending from the reference position of the host vehicle M in the X direction of the host vehicle M, and sets a fourth virtual line IL4 obtained by rotating the third virtual line IL3 by an angel 03 with respect to the third virtual line IL3. Furthermore, the information processor 170 causes the fourth virtual line IL4 to extend by a predetermined distance L3 and sets a tip of the extended fourth virtual line IL4 as a reference position. The reference position is a position of a distance L4 from the host vehicle M in the width direction of the host vehicle M.

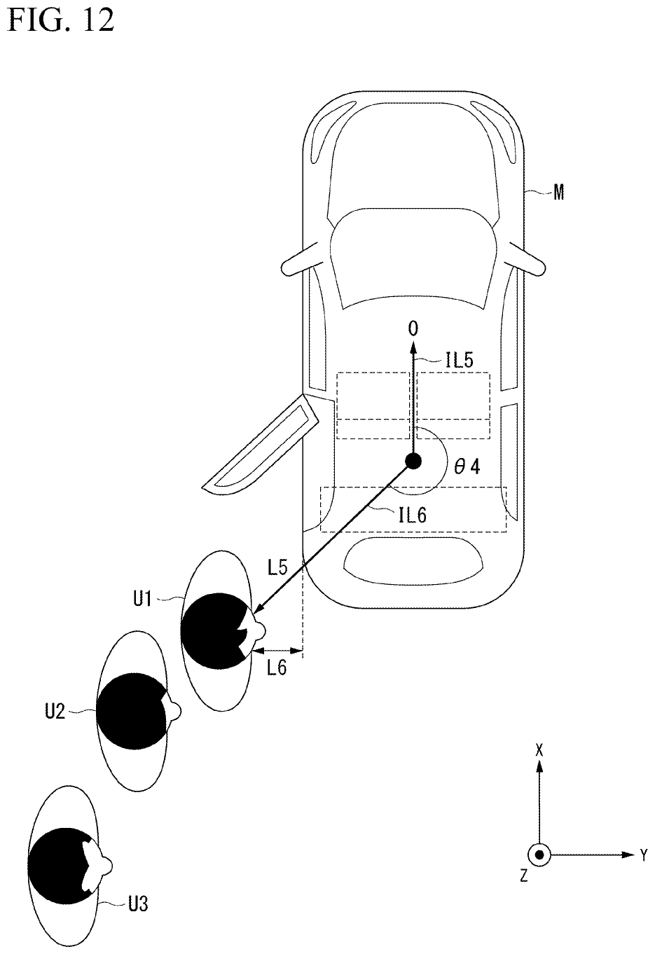

FIG. 12 is a diagram for describing an example of control when the number of the users scheduled to board is two or more. When there are a plurality of users scheduled to board (U1 to U3), the information processor 170 determines, for example, a person present in the closest position from the host vehicle M as a person of interest, and controls the stop position of the host vehicle M to enable this person of interest to preferentially board. The information processor 170 sets a fifth virtual line IL5 extending from the reference position of the host vehicle M in the X direction of the host vehicle M, and sets a sixth virtual line IL6 obtained by rotating the fifth virtual line IL5 by an angle 04 with respect to the fifth virtual line IL5. Furthermore, the information processor 170 causes the sixth virtual line IL6 to extend by a predetermined distance L5 and sets a tip of the extended sixth virtual line IL6 as a reference position. The reference position is a position at a distance L6 from the host vehicle M in the width direction of the host vehicle M. The distance L6 is a distance shorter than the distance L4.

In each processing described above or processing to be described below, a user who preferentially boards the host vehicle M may be determined on the basis of corresponding information indicating users and the boarding order registered in advance and history information on the boarding order in the past. For example, the information processor 170 may refer to the corresponding information and/or the history information and prioritize a specific user over a child for boarding, may prioritize other users over the child holding hands, or may prioritize other users over the user of interest.

### Control in Consideration of Side Step

The host vehicle M may be provided with a side step and the automated driving control device 100 may cause the host vehicle M to stop at a position at which the side step can be used. The automated driving control device 100 may cause the host vehicle M to stop at the position at which the side step can be used when a user (for example, a child or a specific user) estimated to use the side step is included in the users scheduled to board. The information processor 170 refers to, for example, the reference information 181, the user information 182, and the like, and estimates the user estimated to use the side step on the basis of image recognition processing. The side step is a tool that assists a user in boarding the host vehicle M. The side step is, for example, provided below a body of the host vehicle M and below the entrance. This side step is stored in a storage provided below the body of the host vehicle M not to protrude outward in the width direction of the host vehicle M when the door of the host vehicle M is closed, and slides out of the storage to protrude near the entrance when the door of the host vehicle M is open. The users can more easily board the host vehicle M by placing their legs on the protruding side step.

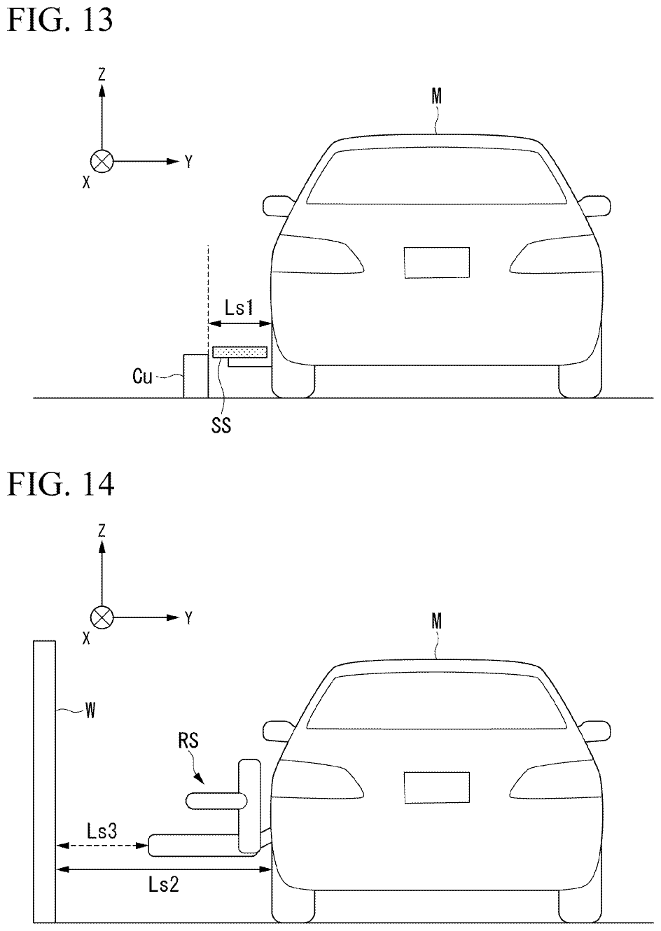

FIG. 13 is a diagram which shows an example of a position at which the host vehicle M provided with the side step allows the users to board. Near the stop area 310, a curbstone Cu is provided. This curbstone Cu has a predetermined height and the curbstone Cu does not hinder opening and closing of the door of the host vehicle M, but the height of the curbstone Cu is equal to or higher than a height at which a side step SS is provided. For this reason, when the side step SS slides and protrudes in the width direction of the host vehicle M, the side step and the curbstone Cu collide with each other. The height of the curbstone Cu is a height which a person can get over.

In this case, the automated driving control device 100 recognizes the curbstone Cu and causes the host vehicle M to stop at the position at which the side step can be used. For example, the automated driving control device 100 separates the curbstone Cu from a left-side end of the host vehicle M by a width Ls1 and causes the host vehicle M to stop. The width Ls1 is a width obtained by adding a margin width to a width of a slide when the side step slides and protrudes.

As a result, the user can easily board the host vehicle M using the side step. For example, the user may board the host vehicle M by getting over a curbstone or may board the host vehicle M, for example, using the side step approaching the entrance of the host vehicle M in a minus X direction or a plus X direction through a place with no curbstones instead of getting over a curbstone.

### Control in Consideration of Lift-Up Seat

The host vehicle M is provided with a lift-up seat, and the automated driving control device 100 takes the lift-up seat out of the vehicle when the vehicle stops. When a user estimated to use the lift-up seat is included in the users scheduled to board, the automated driving control device 100 may take the lift-up seat out of the vehicle when the vehicle stops. The information processor 170 refers to, for example, the reference information 181, the user information 182, and the like, and estimates the user estimated to use the lift-up seat on the basis of image recognition processing.

The lift-up seat is a seat on which the user sits, and a seat main body includes a moving mechanism that can move into or out of a vehicle compartment through an opening of a door on a side of the host vehicle M. The automated driving control device 100 causes the lift-up seat to move out of the vehicle by controlling the moving mechanism when the vehicles stop at the stop position for boarding of the users scheduled to board.

“Taking the lift-up seat out of the vehicle when the vehicle stops” means that the lift-up seat is taken out of the vehicle within a predetermined time after the vehicle stops or a state in which the lift-up seat is taken out of the vehicle when the vehicle stops and is available for the user.

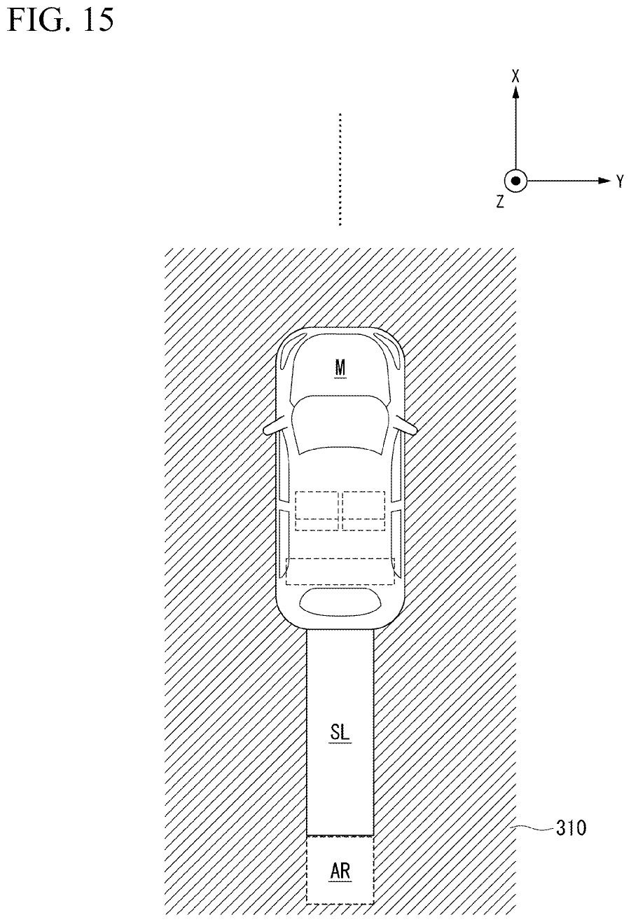

FIG. 14 is a diagram which shows an example of a position at which the host vehicle M provided with the lift-up seat allows a user to board. A wall W is provided near the stop area 310. The automated driving control device 100 recognizes the wall W and causes the host vehicle M to stop at a position at which the lift-up seat RS becomes available. For example, the automated driving control device 100 separates the wall W from the left-side end of the host vehicle M by a width Ls2 and causes the host vehicle M to stop. The width Ls2 is a width obtained by adding a margin width Ls3 to a width of the lift-up seat when the lift-up seat RS protrudes outside the vehicle compartment.

As a result, the user can easily board the host vehicle M using the lift-up seat.

### Control in Consideration of Slope Provided in Vehicle

The host vehicle M is provided with a slope that can be stored, and the automated driving control device 100 takes the slope out of the vehicle when the vehicle stops. When a user (for example, a person who has boarded a wheelchair) estimated to use the slope is included in the users scheduled to board, the automated driving control device 100 may take the slope out of the vehicle when the vehicle stops. The information processor 170 refers to, for example, the reference information 181, the user information 182, and the like, and estimates the user estimated to use the slope on the basis of image recognition processing.

The slope is provided at a rear of the host vehicle M. For example, the automated driving control device 100 can set the slope by opening (lifting up) a rear gate of the host vehicle M and driving a drive mechanism that stores and sets the slope.

FIG. 15 is a diagram which shows an example of a position at which the host vehicle M provided with the slope SL allows a user to board. For example, the automated driving control device 100 causes the host vehicle M to stop at a position at which the slope SL can be set in the stop area 310. The position at which the slope SL can be set is a position at which the slope SL and a surplus area AR can fit in the stop area 310 when it is assumed to set the slope SL.

As a result, the user can easily board the host vehicle M using the slope SL.

According to the first embodiment described above, the automated driving control device 100 can perform an appropriate pick-up operation for the users scheduled to board the vehicle by changing the priority level of an operation when the host vehicle M stops near the users scheduled to board on the basis of the type of the users scheduled to board the host vehicle M.

### Second Embodiment

Hereinafter, a second embodiment will be described. In the second embodiment, a slide door and a hinge door are provided in the host vehicle M. The automated driving control device 100 determines the door of the host vehicle M that is the closest to the person of interest among the users on the basis of one or both of clothes of the users scheduled to board and the type of the users scheduled to board, and causes the host vehicle M to stop such that the determined door is positioned near a position at which the person is present. In the following description, the second embodiment will be described.

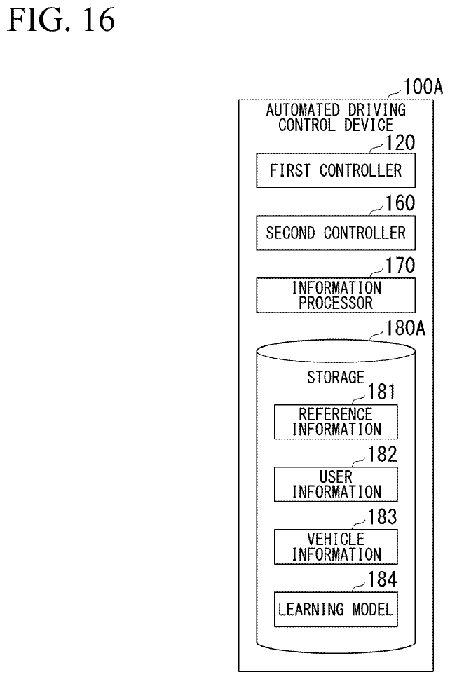

FIG. 16 is a diagram which shows an example of a functional configuration of an automated driving control device 100A according to the second embodiment. The automated driving control device 100A includes, for example, a storage 180A instead of the storage 180 of the first embodiment. The storage 180A may further include a learning model 184 in addition to information stored in the storage 180. The learning model 184 is a model which outputs information indicating whether to determine the stop position based on the slide door or determine the stop position based on the hinge door if information based on an image is input. The learning model 184 may be a model using a neural network or the like, or may be a model in which a predetermined function and a predetermined rule are defined.

The information processor 170 determines the stop position based on the slide door when a result obtained using the learning model 184 is to determine the stop position based on the slide door, and determines the stop position based on the hinge door when a result obtained by using the learning model 184 is to determine the stop position based on the hinge door.

### Flowchart

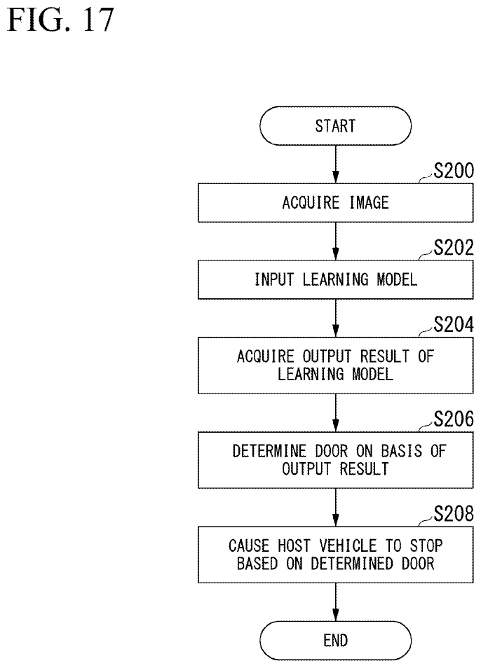

FIG. 17 is a flowchart which shows an example of a flow of processing executed by the automated driving control device 100A according to the second embodiment. The present processing is executed, for example, when the host vehicle M has reached a position at a predetermined distance from the getting-on/off area 320.

First, the information processor 170 acquires an image captured by the camera 10 (step S200). Next, the information processor 170 inputs the image captured in step S100 to the learning model 184 (step S202), and acquires a result of an output by the learning model 184 (step S204).

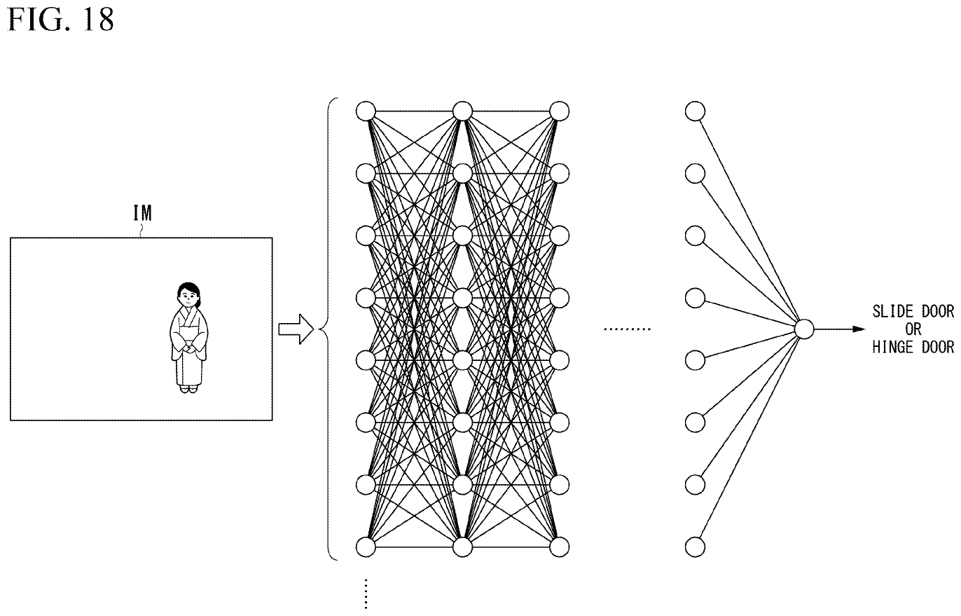

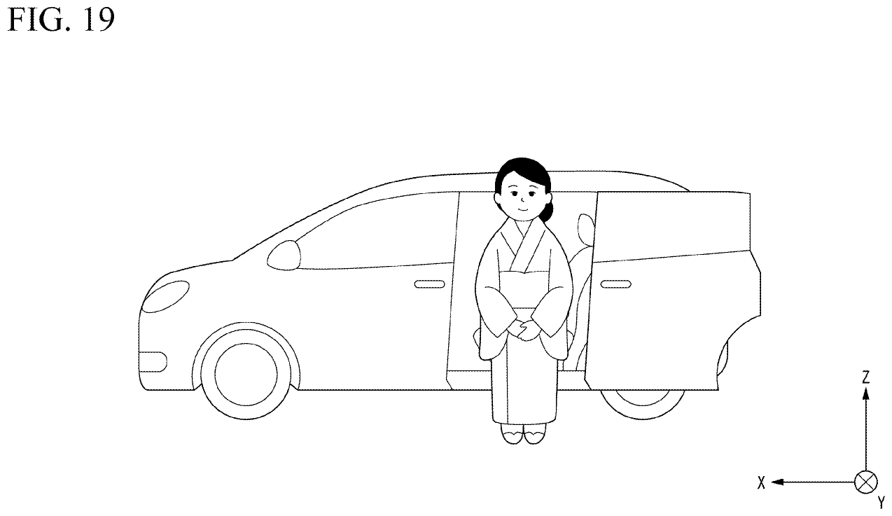

FIG. 18 is a diagram which schematically shows content of processing of steps S200 to S204. In the shown example in FIG. 18, the information processor 170 acquires information indicating which door between the slide door and the hinge door is based to determine the stop position by inputting an image IM to a neural network that is the learning model 184.

The neural network may derive the type of the users scheduled to board included in an image in a middle layer. In this case, the information processor may input information indicating the type of the users to another neural network and acquire information indicating which door is based to determine the stop position on the basis of a result of an output by the another neural network. The other neural network is a model for deriving, if a type of users is input, a type of a door preferred by the users of the input type.

For example, a learning device (not shown) performs learning on the basis of learning data including images in which persons wearing various clothes are captured and the type of doors preferred by the persons in the learning model 184. For example, when a predetermined image is input, the learning device generates the learning model 184 by adjusting a coefficient and a weight of each layer in the neural network such that the type of a door preferred by a user included in the image is output as an output result. For example, if an image is input, the image is an image in which a user wearing clothes such as Japanese clothes, kimono, long skirt, suit, dress, formal wear, or the like, who is hard to get into the host vehicle M from an opening of the hinge door is captured, the learning model 184 outputs information indicating to determine the stop position based on the slide door. The learning model 184 may also be a model generated for each type of a vehicle. In this case, the hinge door may be preferred or the slide door may be preferred for any clothes depending on the type of a vehicle.

Returning to the description of FIG. 17, in step S206, the Information processor 170 determines a reference door for determining the stop position on the basis of a result of the output by the learning model 184 (step S206), and causes the host vehicle M to stop based on the determined door (step S208). As a result, processing of one routine of this flowchart ends.

For example, when the user scheduled to board is wearing a kimono and the reference door is determined to be the slide door, the automated driving control device 100 causes the host vehicle M to stop such that a door provided with the slide door approaches the user wearing the kimono as illustrated in FIG. 19. As a result, the user can smoothly board the host vehicle M.

The learning model 184 may be a mode which outputs information indicating which door among the slide door and the hinge door is based to determine the stop position when an image in which a person is captured is input. In this case, for example, the type of a door according to characteristics of the person regardless of clothes is output.

The automated driving control device 100 may determine the door of the host vehicle M that is the closest to the user of interest on the basis of one or both of the clothes of the user scheduled to board and the type of the user scheduled to board. In this case, for example, when an image in which a person is captured is input, the learning model 184 outputs information indicating which door is based to determine the stop position by taking the clothes and type of a user into account. The automated driving control device 100 may determine a type of the clothes of the user and the type of the user by performing image processing, and determine a reference door on the basis of a result obtained by integrating two scores associated with the determined two types.

According to the second embodiment described above, the automated driving control device 100 determines the door of the host vehicle M that is the closest to the user of interests among the users on the basis of one or both of the clothes of the user scheduled to board and the type of the user scheduled to board and causes the host vehicle M to stop such that the determined door is positioned near a position at which the user is present, thereby providing a pick-up service in consideration of clothing of the user of the vehicle.

The automated driving control device 100 may change the priority level of an operation when the vehicle stops near the user, for example, according to the following states of (a) to (d) regarding the user scheduled to board the host vehicle M instead of (or in addition to) the control described above.

(a) a state in which only an adult is included in the user,

(b) a state in which a child is included in the user,

(c) a state in which an elderly person is included in the user, and

(d) a state in which both a child and an elderly person are included in the user.

For example, a behavior of the vehicle at the time of stopping may be slower in the states of (b), (c), and (d) than in the state of (a), or a distance between the host vehicle M and the user in the width direction of the vehicle may be closer or farther in the state of (b), (c), or (d) than in the state of (a). The automated driving control device 100 may take the lift-up seat or a predetermined on-vehicle equipment out of the vehicle at the time of stopping in the state of (c) or (d). The automated driving control device 100 may change the priority level of an operation when the vehicle stops near the user on the basis of a height and a foot length of the user scheduled to board the host vehicle M instead of (or in addition to) the control described above. The height and the foot length of the user is an example of information indicating the “type of the user.” For example, the automated driving control device 100 may change distances between the host vehicle M and the user in one or both of the width direction and the traveling direction of the vehicle when the vehicle stops near the user according to the height and the foot length such that the user can easily board the host vehicle M.

### Hardware Configuration

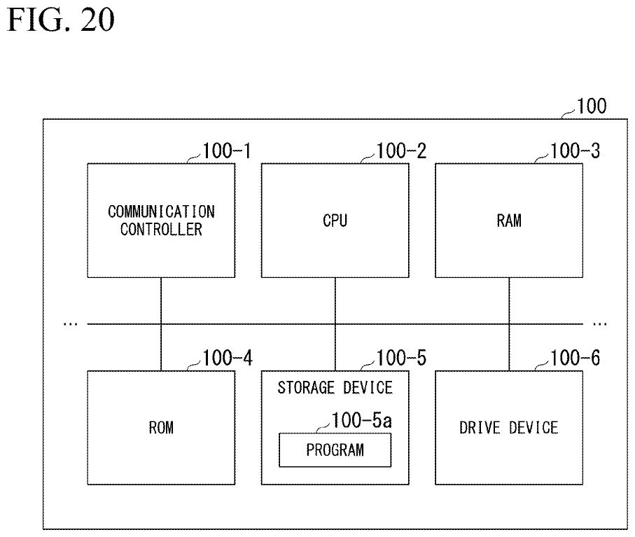

FIG. 20 is a diagram which shows an example of a hardware configuration of the automated driving control device 100 of the embodiments. As shown in FIG. 20, the automated driving control device 100 is configured to include a communication controller 100-1, a CPU 100-2, a random access memory (RAM) 100-3 used as a working memory, a read only memory (ROM) 100-4 that stores a booting program and the like, a storage device 100-5 such as a flash memory or a hard disk drive (HDD), a drive device 100-6, and the like being connected to one another by an internal bus or a dedicated communication line. The communication controller 100-1 communicates with components other than the automated driving control device 100. The storage device 100-5 stores a program 100-5a executed by the CPU 100-2. This program is expanded in the RAM 100-3 by a direct memory access (DMA) controller (not shown) or the like and executed by the CPU 100-2. As a result, some or all of the first controller 120, the second controller 160, and the information processor 170 are realized.

The embodiments described above can be expressed as follows.

A vehicle control device is configured to include a storage device that stores a program and a hardware processor, in which the hardware processor executes the program stored in the storage device, thereby recognizing a vicinity situation of a vehicle, controlling steering and acceleration or deceleration of the vehicle on the basis of the recognized vicinity situation, and changing, on the basis of a type of a user scheduled to board the vehicle, a priority level of an operation when the vehicle stops near the user scheduled to board.

As described above, the forms for implementing the present invention have been described using the embodiments. However, the present invention is not limited to such embodiments, and various modifications and substitutions may be added in a range not departing from the gist of the present invention.

What is claimed is:

1. A vehicle control device comprising:
a vicinity situation recognizer configured to recognize a vicinity situation of a vehicle; and
a driving controller configured to control steering and acceleration or deceleration of the vehicle on the basis of the vicinity situation recognized by the vicinity situation recognizer,
wherein the driving controller changes a priority level of an operation when the vehicle stops near users scheduled to board the vehicle on the basis of a type of the users scheduled to board.

2. The vehicle control device according to claim 1,
wherein, in automated exit processing of causing the vehicle to exit from a parking lot and causing a user of the vehicle to board in a boarding area in which the user is allowed to board, the driving controller changes the priority level of an operation when the vehicle stops near the users scheduled to board on the basis of the type of the users scheduled to board.

3. The vehicle control device according to claim 1,
wherein the type of the users includes at least three types such as an adult, a child, and an elderly person.

4. The vehicle control device according to claim 1,
wherein the type of the users includes a child, and
the driving controller, when the users scheduled to board include one or more children, causes the vehicle to stop such that a door of the vehicle approaches near a position at which a child of interest among the one or more children waits to enable the one or more children to preferentially board the vehicle.

5. The vehicle control device according to claim 4,
wherein the driving controller excludes a child who does not hold hands with one or more adults scheduled to board among the one or more children included in the users scheduled to board from the child of interest.

6. The vehicle control device according to claim 4,
wherein the driving controller causes the vehicle to stop such that a door near a seat equipped with a child seat in a vehicle compartment of the vehicle approaches near the position at which the child of interest waits.

7. The vehicle control device according to claim 6,
wherein the type of the users further includes an elderly person, and
the driving controller, when an elderly person is included in the users scheduled to board in addition to the one or more children, causes the vehicle to move such that the door of the vehicle approaches near a position at which the elderly person waits to enable the elderly person to preferentially board the vehicle after all or some of the one or more children have boarded the vehicle.

8. The vehicle control device according to claim 1,
wherein the driving controller causes the vehicle to stop by controlling, with respect to a width direction of the vehicle, a distance between the vehicle and a user of interest among the users scheduled to board in the width direction according to the number of the users scheduled to board.

9. The vehicle control device according to claim 1,
wherein the vehicle is provided with a side step, and
the driving controller causes the vehicle to stop at a position at which the side step can be used.

10. The vehicle control device according to claim 1,
wherein the vehicle is provided with a lift-up seat, and
the driving controller takes the lift-up seat out of the vehicle after stopping when a user estimated to use the lift-up seat is included in the users scheduled to board.

11. The vehicle control device according to claim 1,
wherein the vehicle is provided with a slide door and a hinge door, and
the driving controller determines a door of the vehicle which is closest to the user of interest among the users on the basis of one or both of clothes of the users scheduled to board and the type of the users scheduled to board, and causes the vehicle to stop such that the determined door is positioned near a position at which the user is present.

12. A vehicle control method comprising:
by a vehicle control device, recognizing a vicinity situation of a vehicle;
controlling steering and acceleration or deceleration of the vehicle on the basis of the recognized vicinity situation; and
changing a priority level of an operation when the vehicle stops near users scheduled to board the vehicle on the basis of a type of the users scheduled to board.

13. A non-transitory computer-readable storage medium that stores a computer program to be executed by a computer to perform at least:
recognize a vicinity situation of a vehicle;
control steering and acceleration or deceleration of the vehicle on the basis of the recognized vicinity situation; and
change a priority level of an operation when the vehicle stops near users scheduled to board the vehicle on the basis of a type of the users scheduled to board.
